(19) United States
(12) Patent Application Publication
(10) Pub. No.: US 2016/0082817 A1
(43) Pub. Date: Mar. 24, 2016

(54) TRUCK BED COVER ASSEMBLY

(71) Applicant: Timothy J. Mulholland, Danville, CA (US)

(72) Inventors: Timothy J. MULHOLLAND, Danville, CA (US); Matthew James Roloff MULHOLLAND, Danville, CA (US)

(73) Assignee: Timothy J. Mulholland, Danville, CA (US)

(21) Appl. No.: 14/856,735

(22) Filed: Sep. 17, 2015

Related U.S. Application Data
(60) Provisional application No. 62/052,177, filed on Sep. 18, 2014.

(51) Int. Cl. B60J 7/12

(52) U.S. Cl. CPC B60J 7/1204; B60J 2007/1213; B60J 2007/1208

(57) ABSTRACT

A truck bed cover assembly includes a driver side cover door and a passenger side cover door and opening mechanisms which are electrically powered to independently open and close each of the cover doors from a closed position at which the cover doors enclose an upper end of the truck bed to an open position which can be varied up to at least 180° from the closed position. The opening mechanisms include a kinematic triangle, an arcing bow and a linear actuator which are arranged to open and close the cover doors

### CROSS-REFERENE TO RELATED APPLICATION

This application claims priority under 35 U.S.C. §119(e) to U.S. Provisional Application No. 62/052,177, filed on Sep. 18, 2014, the entire content of which is incorporated herein by reference.

### FIELD OF THE INVENTION

The present invention relates generally to a double door cover assembly for a truck bed, and more particularly, relating to a double door cover assembly having a pair of rigid doors that can be driven, in an electrically powered mode, to various lockable positions up to at least 180° from a closed position.

### BACKGROUND OF THE INVENTION

Pick-up trucks typically have an open truck bed of various dimensions located aft of the cab of the truck and the open truck bed allows for hauling of different types of cargo and allows easy access to the truck bed. Various covers are available for truck beds such as fabric material and hard tops. Some hard tops are one-piece and pivot at the end of the cargo bed adjacent the driver cab while others are hinged along the sides of the truck bed.

### SUMMARY OF THE INVENTION

Disclosed herein is a truck bed cover assembly that is power operated to open and close double doors from a closed position to an open lockable position which can be varied up to at least 180° from the closed position.

In a first embodiment, the truck bed cover assembly includes driver side and passenger side electrically powered opening mechanisms which can independently open the double doors, the driver side opening mechanism operable to open the driver side cover door to an open lockable position up to at least 180° from the closed position thereby providing a vertical extension in the 90° position to extend the height of the driver sidewall of the truck bed or a horizontal workspace extending outwardly from the truck bed in the 180° position, and the passenger side opening mechanism operable to open the passenger side cover door to an open lockable position up to at least 180° from the closed position thereby providing a vertical extension in the 90° position to extend the height of the passenger sidewall of the truck bed or a horizontal workspace extending outwardly from the truck bed in the 180° position.

In a second embodiment, the cover assembly is detachable and can be installed on various truck beds wherein the driver side and passenger side cover doors can be pivotally mounted on the sidewalls of the truck bed and the opening mechanisms can be mounted in a housing which fits along a front wall adjacent the cab of the truck.

In a third embodiment, each opening mechanism includes a linear actuator pivotally attached at one end to the housing and pivotally attached at an opposite end to a first end of the kinematic triangle, a rail comprising a linear track located on an underside of one of the cover doors, the arcing bow having a first end pivotally attached to the housing and a second end movable along the track from a first position at which the sidewall when the cover door is in a closed position to a second position closer to the sidewall when the cover door is moved to an open position. The arcing bow preferably is a bar or tube with a bend between a longer section slidably attached to the guide rail and a shorter section pivotally attached to the housing and slidably attached to the kinematic triangle via a linear slot in the shorter section which receives a pin at a corner of the kinematic triangle closer to the end pivotally attached to the housing than the end pivotally attached to the linear actuator.

In a fourth embodiment, each opening mechanism includes an actuator telescoping arm which opens a cover door by extending the telescoping arm and moving the cover door to a desired position up to at least 180° from the closed position. To close the cover door, the opening mechanism retracts the telescoping arm to close the cover door. To provide a seal between the opposed edges of the doors, the doors can include overlapping edges with a seal along the edge of one or both doors. To open the door with its edge beneath the edge of the other door, it is necessary to partially open the overlapping door edge far enough to allow freedom of movement of the other door.

In a fifth embodiment, a second end of the kinematic triangle is pivoted to the housing such that the kinematic triangle can be rotated about the second end upon extension of the linear actuator whereupon rotation of the kinematic triangle causes the second end of the arcing bow to move along the track and open the cover door, the linear actuator including a telescopic arm including an internal screw mechanism which can extend and retract the first telescoping arm via an electrically powered motor.

In a sixth embodiment, the driver side and passenger side opening mechanisms are operable to mover the cover doors to the same or different angular orientation at the same or different times. The opening mechanism can include microswitches which are remotely controlled to open and close each cover door.

In a seventh embodiment, each opening mechanism includes a telescoping arm which opens a cover door to a desired position up to at least about 180°. The telescopic arm closes the cover door by retracting the telescopic arm such that the arcing bow rides along a track in the guide rail underneath the cover door and pulls the cover door closed. The telescoping arms are mounted so as to be at a smaller angle with respect to a bottom wall of the housing when the cover doors are closed and a larger angle with respect to the bottom wall of the housing when the cover doors are opened to the fully opened 180° position and beyond. The guide rail can include a linear slot forming the track and the arcing bow can include a pin which slides in the slot.

In an eighth embodiment, the cover doors can include various features to provide functionality such as mounting equipment on the inside or outside of the cover doors and/or storage space inside the cover doors. For example, the cover doors can include a pattern of pre-drilled and plugged holes which can be later opened to attach mounting brackets to support mechanical and/or electrical equipment.

In a ninth embodiment, the cover doors can be adapted to support a transport basket for injured patients or military personnel.

### BRIEF DESCRIPTION OF THE DRAWINGS

The accompanying drawings, which are included to provide further understanding of the invention and are incorporated in and constitute a part of this specification, illustrate preferred embodiments of the invention and together with the description serve to explain the principles of the invention, in which:

FIG. 1 is a perspective view of a conventional truck bed with a cover assembly in accordance with a preferred embodiment wherein the cover doors are in a closed position.

FIG. 2 is the same perspective view of FIG. 1 with the driver side cover door in a partially opened position.

FIG. 3 is the same perspective view of FIG. 1 with the driver side door a half open position.

FIG. 4 is the same perspective view of FIG. 1 with the driver side door in a horizontal position.

FIG. 5 is the same perspective view of FIG. 1 with the driver side door in a fully open position.

FIG. 6 shows details of a hinge mechanism for either cover door.

### DETAILED DESCRIPTION OF THE INVENTION

Reference will now be made in detail to the preferred embodiments of the present invention, examples of which are illustrated in the accompanying drawings.

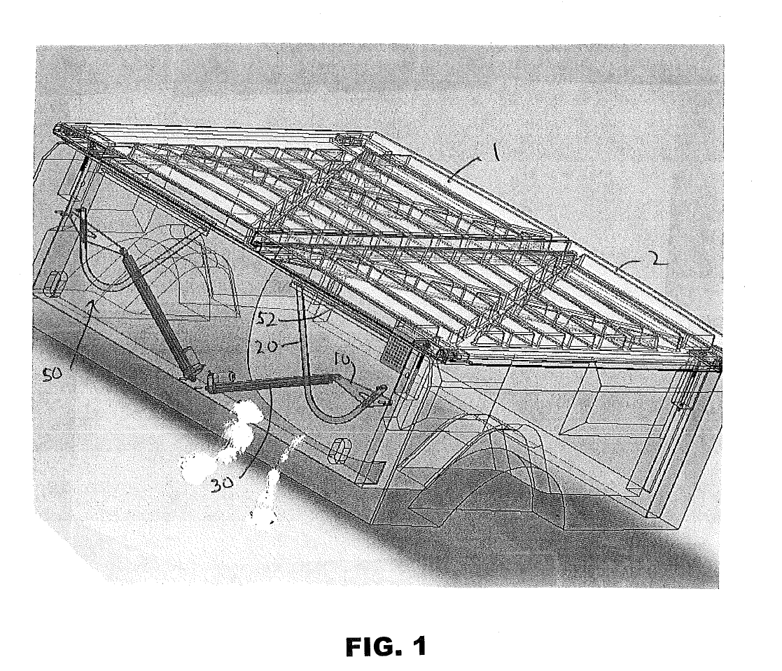

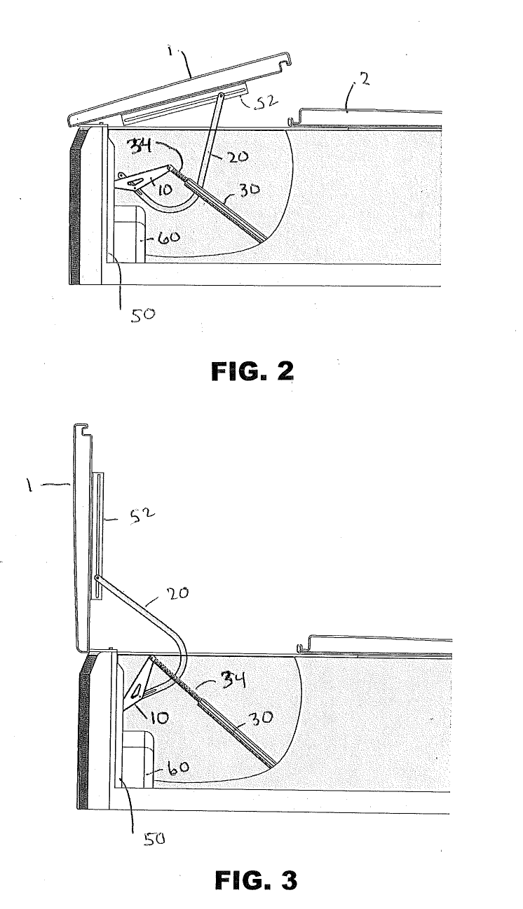

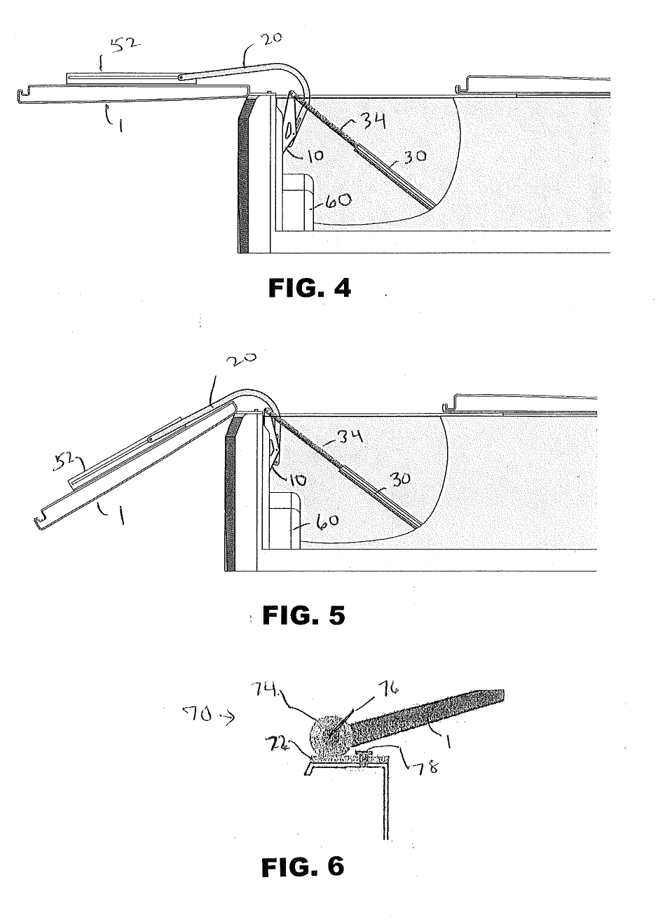

FIG. 1 illustrates an open topped pick-up truck bed with driver side and passenger side cover doors 1, 2 of a cover door assembly constructed in accordance with a preferred embodiment of the present invention shown in a closed configuration. FIG. 2 shows the cover door 1 in a partially open position, FIG. 3 shows the cover door 1 in a half open position at 90° to the closed position, FIG. 4 shows the cover door 1 in a horizontal position at 180° to the closed position, and FIG. 5 shows the cover door 1 at a fully opened position at an angle of about 210° to the closed position.

In one embodiment, the cover door assembly is designed to fit various truck beds by using butterfly anchors which drop into the truck bed's factory rail anchor points. That is, conventional truck beds include predrilled holes which can be used to attach elastomeric cords or bolt attachments to the truck bed. A mounting bracket including an upper plate, lower plate, bushing and fastener such as a bolt can be used to mount the cover doors. The upper plate and the lower plate have a series of holes matching the hole pattern of the rail anchor points of a particular truck model, further details of which are set forth in U.S.PA 2014/0265404, the entire disclosure of which is hereby incorporated by reference. The upper plate and lower plate preferably extend the entire length of the cover doors to provide a continuous hinge along the top of each sidewall of the truck bed. The upper plates include one-half of a hinge connection similar to one plate of a common door hinge. The cover doors have matching hinge connections and can be attached to the upper plates with pins extending the length of the cover doors. Rubber bushings can be mounted around each fastener between the lower plates and the underside of the top wall extending along each sidewall of the truck bed.

As shown in FIG. 1, a housing 50 is located on the end wall (front wall) of the truck bed adjacent the cab. The housing 50 contains the two opening mechanisms (10, 20, 30) for the cover doors 1, 2 and optionally rechargeable power sources 60 such as one or more 12 volt batteries. As shown in FIG. 1, each opening mechanism includes a kinematic triangle 10, arcing bow 20, and linear actuator 30 pivotally attached at one end to the inside of the housing 50 and pivotally attached at an opposite end to a first end of the kinematic triangle 10. The arcing bow 20 has a first end pivotally attached to the inside of the housing 50 and a second end slidably attached for movement along a track 52 from a first position further from the sidewall of the truck bed to a second position closer to the sidewall of the truck bed when the door is moved to an open position.

The truck bed cover assembly is power operated to open and close double doors from a closed position to an open position which can be varied up to 180° or beyond 180° to about 210° from the closed position. In the closed position the cover doors preferably form a waterproof seal along opposed surfaces. A second end of the kinematic triangle 10 is pivotally attached to an inside of the housing 50 such that the kinematic triangle 10 can be rotated about the second end upon extension of the linear actuator 30 whereupon rotation of the kinematic triangle 10 causes the second end of the arcing bow 20 to move along the track 52 and open the cover door. The linear actuator 30 includes a telescopic arm 34 including an internal screw mechanism which can extend and retract the first telescoping arm via an electrically powered motor 60. The kinematic triangle 10 pivotally mounts to three surfaces: to the outboard side-wall of the opening mechanism housing 50, to the lower point of the door linking assembly's arcing bow 20, and to the upper end of the linear actuator 30. Thus, the outboard side-wall of the opening mechanism housing runs parallel to the side wall of the truck and perpendicular to the truck bed's tail gate and the bed's leading/front wall (which is located just aft of the passenger cabin). The upper point of the arcing bow is fitted to ride along the metal slots of the linking assembly's door guide rail 52. The kinematic triangle 10 does not come into direct contact with the linking assembly's door guide rail 52; rather, the kinematic triangle 10 drives the arcing bow 20 which moves along the door guide rail 52.

As can be seen in FIGS. 2-5, the driver side door 1 can be rotated about the sidewall of the truck bed due to sliding movement of the arcing bow 20 in track 52 from a partially opened position (FIG. 2), to a position which provides a vertical extension in the 90° position (FIG. 3), to a horizontal position providing a workspace extending outwardly from the truck bed in the 180° position (FIG. 4) or beyond 180° to about 210° (FIG. 5). Likewise, the passenger side cover door can be opened in the same manner by operating a passenger side opening mechanism to open the passenger side cover door to an open position up to at least 180° from the closed position, e.g., provide a vertical extension in the 90° position to extend the height of the passenger sidewall of the truck bed or a horizontal workspace extending outwardly from the truck bed in the 180° position or beyond 180° to 210°.

In a second embodiment, the truck bed cover assembly can be installed on various truck beds. For example, the double doors 1, 2 can be pivotally mounted on the sidewalls of the truck bed and the opening mechanisms can be mounted in a housing such as an enclosed rectangular box made of metal such as steel or aluminum or composite materials located along a front wall adjacent the cab of the truck.

In a third embodiment, each opening mechanism includes the kinematic triangle 10 as described above which allows the linear actuator 30 to be mounted on a bottom wall of the housing 50 rather than along the front wall of the truck bed as in U.S.PA 2014/0265404. Mounting the linear actuator on the bottom wall provides added strength and stability to the opening mechanism which can include manual locking arrangements to lock the doors in any desired position. For example, the kinematic triangle can include crenellations in an angle support flange which allows for manual insertion of a male locking piece through the kinematic triangle to rest in the desired crenellation to securely lock the door at positions such as 45°, 90°, 180°, 210°, or any angle therebetween.

In a fourth embodiment, each opening mechanism includes the linear actuator 30 as described above which opens a cover door by extending the telescoping arm to open the cover door to a desired position up to at least 180° from the closed position. To close the cover door, the opening mechanism retracts the telescoping arm to close the cover door. To provide a seal between the opposed edges of the doors, the doors can include overlapping edges with a seal along the edge of one or both doors. To open the door with its edge beneath the edge of the other door, it is necessary to partially open the overlapping door edge far enough to allow freedom of movement of the other door.

In a fifth embodiment, the cover doors are pivotally mounted on tops of the sidewalls of the truck bed by hinge assemblies. In a preferred embodiment, heavy duty hinges are located along the outside edges of each door. For example, each door can include at least two or three hinges and the hinges can be barrel hinges which are bolted or welded to the tops of the truck sidewalls and undersides of the doors. Such barrel hinges include male and female components in which the male component includes a plate bolted or welded onto the top of the sidewall of the truck body (or underside of one of the cover doors) and the female component includes a plate bolted or welded onto the underside of a cover door (or top of the sidewall). The male component includes a longitudinally extending pin fitted in a recess of the female component and a grease fitting can be provided on an end of the female component to lubricate the clearance between the pin and recess. Suitable hinges include grade eight hardened steel hinges available from Conquest Armored Vehicles. Other heavy duty hinges include weld-on barrel hinges as disclosed in U.S. Pat. No. 7,730,581, the disclosure of which is hereby incorporated by reference. Alternatively, as shown I FIG. 6, each hinge assembly 70 can include an upper plate 72 with a hinge connection 74, 76 on an upper surface of the upper plate, a plurality of through holes extending between the upper surface and a lower surface of the upper plate, a lower plate (not shown) having through holes aligned with the holes in the upper plate, fasteners 78 extending through the holes in the upper plate and the lower plate and passing through factory rail anchor points in the truck bed, and a rubber bushing around each fastener and clamped between the lower plate and an underside of the truck bed top wall of the driver sidewall or passenger sidewall. The hinge assemblies 70 can be a full length hinge assemblies which extend the entire length of the cover doors.

In a sixth embodiment, the opening mechanism includes microswitches which are remotely controlled to open and close each cover door. The remote control can include a remote control transmitter and a receiver electrically connected to each motor such that each cover door can be independently opened or closed by a person operating the remote control transmitter.

In a seventh embodiment, the telescoping arms are mounted so as to be at a smaller angle with respect to the bottom wall of the housing when the doors are closed and a larger angle with respect to the bottom wall when the doors are opened to the fully opened 180° position.

In an eighth embodiment, the cover doors can include various features to provide functionality such as mounting equipment on the inside or outside of the cover doors and/or storage space inside the cover doors. For example, the doors can be rigid roto-molded plastic doors designed to mount devices to support: electrical equipment; such as, those used in all manner of visual advertisements, audio speakers, and spotlights, infrared or LED light fixtures, cameras, flat panel TV screens, or the like; and hardware, such as hand tools, power tools, ladders, or the like; and recreational gear, including bicycles, kayaks, and canoes, or the like; and public safety implements for firefighting, search and rescue, military, and police uses. The doors' roto-molding processes allow for the custom integration and personalization aesthetic features; such as, color, finish, and labeling and for the continuous adaption of aesthetic features after installation and provide decades of durability against the effects of weather and use. For military or police use, the cover doors can be integrated with ballistic protection such as five ply level-four KEVLAR matting during the roto-molding production process and hollow channels can be fashioned inside the roto-molded doors to provide additional storage and to create points of leverage to support bracing for the lifting of heavy loads around and to and from the truck's bed.

In a ninth embodiment, the cover doors can be adapted during the roto-molding process to include a plethora of mounts and braces to support equipment such as a transport basket for injured patients or military personnel and/or collapsible military assault ladders.

It will be appreciated by those of ordinary skill in the art that the present invention can be embodied in other specific forms without departing from the spirit or essential characteristics thereof. The presently disclosed embodiments are therefore considered in all respects to be illustrative, and not restrictive. The scope of the invention is indicated by the appended claims, rather than the foregoing description, and all changes that come within the meaning and range of equivalence thereof are intended to be embraced therein.

What is claimed is:

1. A truck bed cover assembly includes a driver side cover door and a passenger side cover door and electrically powered opening mechanisms which independently open and close each of the cover doors from a closed position at which the cover doors enclose an upper end of the truck bed to an open position which can be varied up to at least 180° from the closed position, each of the opening mechanisms including a kinematic triangle, arcing bow and linear actuator.

2. The truck bed cover assembly of claim 1, wherein driver side and passenger side electrically powered opening mechanisms can independently open the double doors, the driver side opening mechanism operable to open the driver side cover door to an open lockable position up to at least 180° from the closed position thereby providing a vertical extension in the 90° position to extend the height of the driver sidewall of the truck bed or a horizontal workspace extending outwardly from the truck bed in the 180° position, and the passenger side opening mechanism operable to open the passenger side cover door to an open lockable position up to at least 180° from the closed position thereby providing a vertical extension in the 90° position to extend the height of the passenger sidewall of the truck bed or a horizontal workspace extending outwardly from the truck bed in the 180° position.

3. The truck bed cover assembly of claim 1, wherein the cover assembly is detachable and can be installed on various truck beds wherein the driver side and passenger side cover doors can be pivotally mounted on the sidewalls of the truck bed and the opening mechanisms can be mounted in a housing which fits along a front wall adjacent the cab of the truck.

4. The truck bed cover assembly of claim 3, wherein each opening mechanism includes a linear actuator pivotally attached at one end to the housing and pivotally attached at an opposite end to a first end of the kinematic triangle, a rail comprising a linear track located on an underside of one of the cover doors, the arcing bow having a first end pivotally attached to the housing and a second end movable along the track from a first position away from the sidewall when the cover door is in a closed position to a second position closer to the sidewall when the cover door is moved to an open position.

5. The truck bed cover assembly of claim 4, wherein a second end of the kinematic triangle is pivoted to the housing such that the kinematic triangle can be rotated about the second end upon extension of the linear actuator whereupon rotation of the kinematic triangle causes the second end of the arcing bow to move along the track and open the cover door, the linear actuator including a telescopic arm including an internal screw mechanism which can extend and retract the first telescoping arm via an electrically powered motor.

6. The truck bed cover assembly of claim 5, further including a rechargeable power source which is electrically connected to the electrical system of the truck and the motor.

7. The truck bed cover assembly of claim 6, wherein the driver side and passenger side opening mechanisms are operable to mover the cover doors to the same or different angular orientation at the same or different times.

8. The truck bed cover assembly of claim 1, wherein each opening mechanism includes a telescoping arm which opens a cover door by extending the telescoping arm to open the cover door to a desired position up to 210° from the closed position.

9. The truck bed cover assembly of claim 8, wherein the opening mechanism closes the cover door by retracting the telescoping arm to close the cover door.

10. The truck bed cover assembly of claim 1, wherein the cover doors are pivotally mounted on tops of the sidewalls of the truck bed by hinge assemblies.

11. The truck bed cover assembly of claim 1, wherein the cover doors are pivotally mounted on tops of the sidewalls of the truck bed by a plurality of weld-on barrel hinges.

12. The truck bed cover assembly of claim 1, wherein the opening mechanisms include microswitches which are remotely controlled to open and close each cover door.

13. The truck bed cover assembly of claim 4, wherein the telescoping arms are mounted so as to be at a smaller angle with respect to a bottom wall of the housing when the cover doors are closed and a larger angle with respect to the bottom wall of the housing when the cover doors are opened to the fully opened 180° position.

14. The truck bed cover assembly of claim 4, wherein the rail includes a linear slot forming the track and the arcing bow includes a pin which slides in the linear slot.
